(19) United States
(12) Patent Application Publication
(10) Pub. No.: US 2021/0357059 A1
(43) Pub. Date: Nov. 18, 2021

(54) TOUCH PANEL AND DISPLAY DEVICE

(71) Applicant: WUHAN CHINA STAR OPTOELECTRONICS SEMICONDUCTOR DISPLAY TECHNOLOGY CO., LTD., Wuhan (CN)

(72) Inventor: Liang Fang, Wuhan (CN)

(21) Appl. No.: 17/251,748

(22) PCT Filed: Jun. 24, 2020
(86) PCT No.: PCT/CN2020/098145

§ 371 Date: Dec. 11, 2020

(30) Foreign Application Priority Data
May 18, 2020 (CN) 202010421829.4

(51) Int. Cl. G06F 3/041

(52) U.S. Cl. CPC G06F 3/0412

(57) ABSTRACT

The present disclosure provides a touch panel and a display device. The touch panel includes touch modules and touch signal lines. One end of each of the touch signal lines is electrically connected to the touch module correspondingly, and another end of the each of the touch signal lines extends to a display integrated module. Multiple touch signals can be collected in multiple different collection areas, and the width of the connection module corresponding to each of the connection areas is different. As a result, the routing design of the touch signal lines is improved, and the design of narrow bezel of the touch panel is realized, which reduces the production cost and improves the display quality.

### BACKGROUND

### 1. Field of the Invention

The present disclosure relates to the field of display technology, more particularly, to a touch panel and a display device.

### 2. Description of the Related Art

With the development of display technology, display devices have been widely used in various fields.

Current display devices mainly include liquid crystal displays, plasma display panels (PDPs), organic electroluminescent devices, and active matrix organic electroluminescent devices, etc. Touch function has become one of the standard configurations of most display devices, in which capacitive touch screens are the most widely used. An important touch technology of the common capacitive touch panels is self capacitance. In the self-capacitive touch panel, individual touch sensor modules are often used, and each of the touch sensor modules corresponds to a touch signal line. The touch signal lines are collected in a lower periphery of the panel to form a signal line collection area. However, for the touch display panel in the related art with the above structure type, the width of the collection area increases accordingly when the signal lines are collected in the lower periphery as the number of the touch signal lines increases and the line width increases. As a result, the display panel has a wider lower bezel and design area when being designed, which is disadvantageous to the design of a narrow bezel display panel.

Therefore, there is a need to provide a touch panel and a display device so as to resolve the problem of the related art.

### SUMMARY

### Technical Problem

In summary, in the touch display panel in the related art, it is easy to form a wider lower bezel to cause a larger lower bezel of the display panel after the touch signal lines are collected on a bottom of the panel, which is disadvantageous to the design of a narrow bezel display panel.

### Technical Solution

In order to resolve the above problem, the present disclosure provides a touch panel and a display device to resolve the problem that the width of the lower bezel of the touch panel in the related art is larger, and the touch signal lines occupy a larger space after being collected at the lower bezel, which is disadvantageous to the design of a narrow bezel display panel.

In order to resolve the above technical problem, the technical scheme provided by the embodiments of the present disclosure is as follows.

According a second aspect of the present disclosure, a touch panel comprising a display area and a non-display area adjacent to the display area is provided. The touch panel comprises:

touch modules, arranged in an array being disposed in the display area of the touch panel; and

touch signal lines, one end of each of the touch signal lines being electrically connected to the touch module correspondingly, another end of the each of the touch signal lines extending into the non-display area;

wherein a display integrated module, at least one touch integrated module, and at least one connection module are disposed in the non-display area, the connection module is electrically connected to the touch integrated module correspondingly, and the another end of the each of the touch signal lines is electrically connected to the connection module correspondingly;

the touch integrated module comprises a first touch integrated module and a second touch integrated module, and the first touch integrated module and the second touch integrated module are symmetrically disposed along a center line of the touch panel;

the touch signal lines corresponding to a same column are disposed in parallel and at equal intervals.

According to another embodiment of the present disclosure, the non-display area comprises a bezel area and a bendable area, the bezel area and the bendable area are disposed adjacent to each other, and the bendable area is close to an edge of the touch panel.

According to another embodiment of the present disclosure, the connection module comprises a straight portion and a vertical portion, the straight portion is disposed in the bezel area, the vertical portion is disposed in the bendable area, and the vertical portion is perpendicular to the straight portion.

According to another embodiment of the present disclosure, the another end of each of the plurality of touch signal lines corresponding to the same column are at least collected in a collection area and are electrically connected to the straight portion correspondingly, the vertical portion is electrically connected to the touch integrated module.

According to another embodiment of the present disclosure, a width of the straight portion is gradually decreased from an end where the straight portion intersects the vertical portion towards another end of the straight portion.

According to another embodiment of the present disclosure, a distance between two adjacent vertical portions is greater than a width of the touch module.

According to another embodiment of the present disclosure, a width of the collection area corresponding to the straight portion is equal to a product of a number of the touch signal lines correspondingly connected to the connection module and a sum of a spacing between two adjacent touch signal lines and a width of the touch signal line.

According a second aspect of the present disclosure, a touch panel comprising a display area and a non-display area adjacent to the display area is provided. The touch panel comprises:

touch modules, arranged in an array being disposed in the display area of the touch panel; and

touch signal lines, one end of each of the touch signal lines being electrically connected to the touch module correspondingly, another end of the each of the touch signal lines extending into the non-display area;

wherein a display integrated module, at least one touch integrated module, and at least one connection module are disposed in the non-display area, the connection module is electrically connected to the touch integrated module correspondingly, and the another end of the each of the touch signal lines is electrically connected to the connection module correspondingly.

According to another embodiment of the present disclosure, the non-display area comprises a bezel area and a bendable area, the bezel area and the bendable area are disposed adjacent to each other, and the bendable area is close to an edge of the touch panel.

According to another embodiment of the present disclosure, the connection module comprises a straight portion and a vertical portion, the straight portion is disposed in the bezel area, the vertical portion is disposed in the bendable area, and the vertical portion is perpendicular to the straight portion.

According to another embodiment of the present disclosure, the another end of each of the plurality of touch signal lines corresponding to the same column are at least collected in a collection area and are electrically connected to the straight portion correspondingly, the vertical portion is electrically connected to the touch integrated module.

According to another embodiment of the present disclosure, a width of the straight portion is gradually decreased from an end where the straight portion intersects the vertical portion towards another end of the straight portion.

According to another embodiment of the present disclosure, a distance between two adjacent vertical portions is greater than a width of the touch module.

According to another embodiment of the present disclosure, a width of the collection area corresponding to the straight portion is equal to a product of a number of the touch signal lines correspondingly connected to the connection module and a sum of a spacing between two adjacent touch signal lines and a width of the touch signal line.

According to another embodiment of the present disclosure, the touch signal lines corresponding to a same column are disposed in parallel and at equal intervals.

According to another embodiment of the present disclosure, the touch integrated module comprises a first touch integrated module and a second touch integrated module, and the first touch integrated module and the second touch integrated module are symmetrically disposed along a center line of the touch panel.

According a third aspect of the present disclosure, a display device comprising the touch panel having a display area and a non-display area adjacent to the display area is provided. The touch panel comprises:

touch modules, the touch modules arranged in an array being disposed in the display area of the touch panel; and

touch signal lines, one end of each of the touch signal lines being electrically connected to the touch module correspondingly, another end of the each of the touch signal lines extending into the non-display area;

wherein a display integrated module, at least one touch integrated module, and at least one connection module are disposed in the non-display area, the connection module is electrically connected to the touch integrated module correspondingly, and the another end of the each of the touch signal lines is electrically connected to the connection module correspondingly.

### Advantageous Effects

The present disclosure provides a touch panel and a display device. Multiple touch integrated modules are disposed in the non-display area of the touch panel, and the corresponding touch signal lines in the display area are extended to their corresponding connection modules. Multiple touch signal lines in a same column are collected in at least one collection area, and are then connected to at least one touch integrated module to realize the transmission of touch signals. When being connected, multiple touch signals can be collected in multiple different collection areas, and the width of the connection module corresponding to each of the connection areas is different. As a result, the routing design of the touch signal lines is improved, and the design of narrow bezel of the touch panel is realized, which reduces the production cost and improves the display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a structure of a touch panel according to one embodiment of the present disclosure.

FIG. 2 is a schematic diagram of a structure of another touch panel according to one embodiment of the present disclosure.

FIG. 3 is a schematic diagram of a structure of still another touch panel according to one embodiment of the present disclosure.

### DESCRIPTION OF THE EMBODIMENTS

For the purpose of description rather than limitation, the following provides such specific details as a specific system structure, interface, and technology for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details.

As the size of the display device increases, the number of the corresponding touch signal lines also increases, which in turn causes the width of the touch signal line collection area to become wider. Finally, the touch display panel in the related art has a wider lower bezel, which can not reduce the production cost and realize the design of narrow bezel panels.

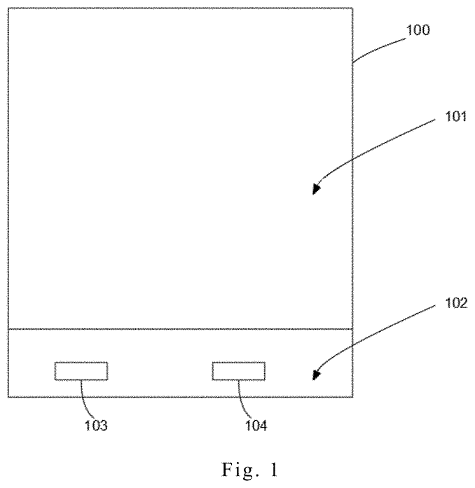

As shown in FIG. 1, FIG. 1 is a schematic diagram of a structure of a touch panel according to one embodiment of the present disclosure. A touch panel 100 comprises a display area 101 and a non-display area 102. The display area 101 and the non-display area 102 are disposed adjacent to each other.

The display area 101 is a display area and a touch area of the touch panel 100, which is a normal light-emitting and touch function area of the touch panel 100. In order to realize the touch function of the touch panel 100, a plurality of touch modules are disposed in the display area 101. The touch modules receive and transmit touch instructions to complete touch operations of the panel.

A width of the non-display area 102 of the touch panel 100 is narrower, and the touch panel 100 is a narrow bezel touch display panel.

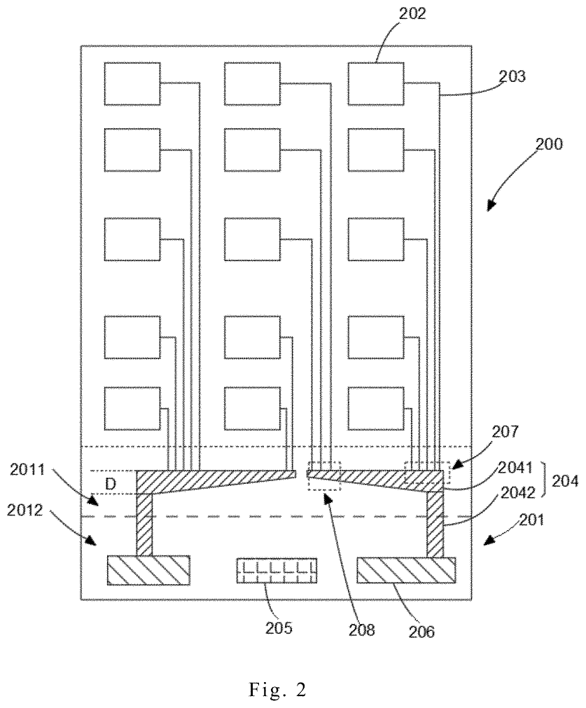

As shown in FIG. 2, FIG. 2 is a schematic diagram of a structure of another touch panel according to one embodiment of the present disclosure. The touch panel comprises a display area 200 and a non-display area 201. The display area 200 and the non-display area 201 are disposed adjacent to each other. The display area 200 is a display touch operation area of the touch panel. The non-display area 201 may be a bezel area or other non-display function area.

The non-display area 201 further comprises a bezel area 2011 and a bendable area 2012. The bezel area 2011 and the bendable area 2012 are disposed adjacent to each other. The bezel area 2011 is close to the display area 200, and the bendable area 2012 is disposed close to an edge of the touch panel.

A bending area is further disposed between the bezel area 2011 and the bendable area 2012. The bending area is used as a boundary of the bezel area 2011 and the bendable area 2012 for bending. In the embodiment of the present disclosure, a width of the bezel area 2011 is H1, a width of the bendable area 2012 is H2. Preferably, H2>H1, the bending performance of the touch panel can thus be ensured.

The display area 200 further comprises touch modules 202 and touch signal lines 203 in it. The touch modules 202 may be arranged in an array in a row direction and a column direction in the display area 200. At the same time, each of the touch modules 202 is connected to one of the touch signal lines 203 correspondingly.

In the embodiment of the present disclosure, the touch modules 202 are described by taking a 3×5 array as an example, that is, the touch modules 202 have a structure of 5 rows and 3 columns in the display area 200.

One end of each of the touch signal lines 203 is electrically connected to its corresponding touch module 202. After the connection with the touch module 202 is completed, another part of the touch signal line 203 can perpendicularly extend into the no-display area 201 of the touch panel. That is, another end of the touch signal line 203 extends into the non-display area 201.

When the plurality of touch signal lines 203 are arranged, the touch signal lines 203 connected to the touch modules 202 in an area corresponding to a same column may be disposed in parallel with one anther and at equal intervals.

A touch integrated module 206 and a display integrated module 205 are further disposed in the bendable area 2012 in the non-display area 201. There may be two touch integrated modules 206 respectively disposed in edge regions on two sides of the touch panel. The touch integrated module 206 and the display integrated module 205 respectively receive a touch signal and a display signal and transmit them to an inside of the panel.

The touch panel further comprises at least one connection module 204. The connection module 204 is disposed in the non-display area 201.

The connection module 204 comprises a straight portion 2041 and a vertical portion 2042. The straight portion 2041 and the vertical portion 2042 are connected to each other. At the same time, the straight portion 2041 is disposed in the bezel area 2011 in the non-display area 201, and an edge of the straight portion 2041 may be in parallel with the lower bezel of the touch panel.

The vertical portion 2042 may be in parallel with left and right bezels of the touch panel or perpendicular to the lower bezel of the touch panel. In addition, another end of the vertical portion 2042 is electrically connected to the touch integrated module 206. Therefore, one part of the vertical portion 2042 is disposed in the bezel area 2011, and another part of the vertical portion 2042 is disposed in the bendable area 2012.

As for the straight portion 2041 of the connection module 204, another end of each of the touch signal lines 203 in the same column are collected on the straight portion(s) 2041 correspondingly, and form at least one collection area. Since the touch modules 202 are arranged in three columns in the embodiment of the present disclosure, multiple collection areas will be formed after being collected, such as a first collection area 207 and a second collection area 208. The touch signal lines 203 in the collection area are correspondingly connected to signal lines in the connecting portion 204 to realize signal transmission.

The connection module 204 is similar to an inverted “L” structure. A width of the straight portion 2041 may be gradually decreased from a bending part of the connection module 204 towards one end of the straight portion 2041 to save production cost. At the same time, due to the reduced width in different regions, it is more advantageous to the realization of the narrow bezel touch panel and the improvement of the reliability of the panel.

The connection module 204 may further be in a “T” shape or have some other structure to facilitate the connection of the corresponding touch signal line 203 with the connection module 204.

The touch signal lines 203 corresponding to the same column may be collected on the same touch integrated module 206, or may be collected on different touch integrated modules 206. As shown in FIG. 2, two touch signal lines 203 of the touch signal lines 203 in a second column are collected on the touch integrated module 206 on a left side, and the remaining three touch signal lines 203 are collected in the second collection area 208 corresponding to the other touch integrated module 206. Thus, the arrangement of the touch signal lines 203 is more flexible and reasonable.

When the straight portion 2041 is disposed, a width of the straight portion 2041 at a junction of the touch signal lines 203 and the straight portion 2041 is W. The width W is equal to a product of a number of the touch signal lines 203 correspondingly connected to the connection module 204 and a sum of a spacing between two adjacent touch signal lines 203 and a width of the touch signal line 203.

In the present embodiment, take the first collection area 207 for example. The first collection area 207 is formed by collecting the touch signal lines 203 at an outermost edge. A width of the collection area corresponding to the first collection area 207 is D. As shown in the figure, in order to achieve the best design structure of the straight portion 2041, the width of the collection area D=7×(the width of the touch signal line 203+the spacing between two adjacent touch signal lines 203). The sum of the width of the touch signal line 203 and the spacing between two adjacent touch signal lines 203 is P, that is, D=7P. Through the structural relationship in the embodiment of the present disclosure, the width of the bezel area 2011 can be effectively reduced, thereby realizing the narrow bezel design and reducing the production cost of the touch panel.

In the embodiment of the present disclosure, the two touch integrated modules 206 can be symmetrically disposed along a center line of the touch panel to simplify the processing and improve the production efficiency of the touch panel.

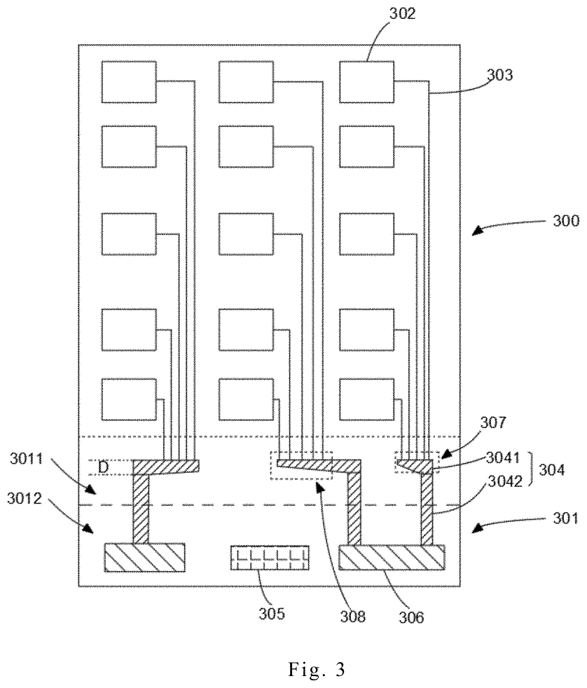

As shown in FIG. 3, FIG. 3 is a schematic diagram of a structure of still another touch panel according to one embodiment of the present disclosure. A touch panel comprises a display area 300 and a non-display area 310 adjacent to the display area 300.

A plurality of touch modules 302 arranged in an array are further disposed in the display area 300. Each of the touch modules 302 is electrically connected to one end of a touch signal line 303 correspondingly. Another end of the touch signal line 303 extends into the non-display area 301.

The non-display area 301 further comprises a bezel area 3011 and a bendable area 3012 disposed adjacent to each other. A width of the bendable area 3012 is greater than a width of the bezel area 3011.

A description is provided with reference to the schematic diagram of the structure of the touch panel in FIG. 3. In the embodiment of the present disclosure, at least one touch integrated module 306 and a display integrated module 305 are further disposed in the bendable area 3012 in the non-display area 301.

The touch panel further comprises at least one connection module 304. The connection module 304 is electrically connected to the another end of the touch signal line 303 at one end. At the same time, another end of the connection module 304 is electrically connected to the touch integrated module 306. The connection module 304 comprises a vertical portion 3042 and a straight portion 3041. The straight portion 3041 is disposed in the bezel area 3011. One end of the vertical portion 3042 is connected to the touch integrated module 306, and another end is connected to the straight portion 3041.

A difference between the present embodiment and the touch panel in FIG. 2 lies in that one connection module 304 is disposed in a region corresponding to each column according to the present embodiment. Therefore, the touch signal lines 303 in a same column are all electrically connected to the connection module 304 corresponding to them. Shapes of the straight portions 3041 of the connection modules 304 may be the same or different. In this manner, a length of the straight portion 3041 can be further shortened to effectively save design area and cost. At the same time, a width D of an outermost collection area becomes D=SP. Since each of the connection modules 304 is connected to the touch signal line 303 in the corresponding column, there is only one collection area on each of the connection modules 304.

In the embodiment of the present disclosure, a distance between two adjacent vertical portions 3042 may be greater than a width of each of the touch modules 302, so as to prevent the touch signal lines 303 coming out of the touch modules 302 from interfering with each other. The reliability of the touch panel is improved.

The embodiment of the present disclosure further provides a display device. The display device comprises the touch panel according to the embodiment of the present disclosure. The touch signal lines, the touch modules and the connection modules in the touch panel are disposed according to the structures provided in the embodiments of the present disclosure. Thus, the design of the narrow bezel touch panel is realized, the production cost is reduced, and the reliability of the display device is improved.

The touch panel and display device according to the the embodiments of the present disclosure are described in detail above, and the description of the above embodiments is only used to facilitate the understanding of the technical solutions and core concepts of the present disclosure.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A touch panel, comprising a display area and a non-display area adjacent to the display area, the touch panel comprising:
touch modules, arranged in an array being disposed in the display area of the touch panel; and
touch signal lines, one end of each of the touch signal lines being electrically connected to the touch module correspondingly, another end of the each of the touch signal lines extending into the non-display area;
wherein a display integrated module, at least one touch integrated module, and at least one connection module are disposed in the non-display area, the connection module is electrically connected to the touch integrated module correspondingly, and the another end of the each of the touch signal lines is electrically connected to the connection module correspondingly;
the touch integrated module comprises a first touch integrated module and a second touch integrated module, and the first touch integrated module and the second touch integrated module are symmetrically disposed along a center line of the touch panel;
the touch signal lines corresponding to a same column are disposed in parallel and at equal intervals.

2. The touch panel as claimed in claim 1, wherein the non-display area comprises a bezel area and a bendable area, the bezel area and the bendable area are disposed adjacent to each other, and the bendable area is close to an edge of the touch panel.

3. The touch panel as claimed in claim 2, wherein the connection module comprises a straight portion and a vertical portion, the straight portion is disposed in the bezel area, the vertical portion is disposed in the bendable area, and the vertical portion is perpendicular to the straight portion.

4. The touch panel as claimed in claim 3, wherein the another end of each of the plurality of touch signal lines corresponding to the same column are at least collected in a collection area and are electrically connected to the straight portion correspondingly, the vertical portion is electrically connected to the touch integrated module.

5. The touch panel as claimed in claim 3, wherein a width of the straight portion is gradually decreased from an end where the straight portion intersects the vertical portion towards another end of the straight portion.

6. The touch panel as claimed in claim 3, wherein a distance between two adjacent vertical portions is greater than a width of the touch module.

7. The touch panel as claimed in claim 4, wherein a width of the collection area corresponding to the straight portion is equal to a product of a number of the touch signal lines correspondingly connected to the connection module and a sum of a spacing between two adjacent touch signal lines and a width of the touch signal line.

8. A touch panel, comprising a display area and a non-display area adjacent to the display area, the touch panel comprising:
touch modules, arranged in an array being disposed in the display area of the touch panel; and
touch signal lines, one end of each of the touch signal lines being electrically connected to the touch module correspondingly, another end of the each of the touch signal lines extending into the non-display area;
wherein a display integrated module, at least one touch integrated module, and at least one connection module are disposed in the non-display area, the connection module is electrically connected to the touch integrated module correspondingly, and the another end of the each of the touch signal lines is electrically connected to the connection module correspondingly.

9. The touch panel as claimed in claim 8, wherein the non-display area comprises a bezel area and a bendable area, the bezel area and the bendable area are disposed adjacent to each other, and the bendable area is close to an edge of the touch panel.

10. The touch panel as claimed in claim 9, wherein the connection module comprises a straight portion and a vertical portion, the straight portion is disposed in the bezel area, the vertical portion is disposed in the bendable area, and the vertical portion is perpendicular to the straight portion.

11. The touch panel as claimed in claim 10, wherein the another end of each of the plurality of touch signal lines corresponding to the same column are at least collected in a collection area and are electrically connected to the straight portion correspondingly, the vertical portion is electrically connected to the touch integrated module.

12. The touch panel as claimed in claim 10, wherein a width of the straight portion is gradually decreased from an end where the straight portion intersects the vertical portion towards another end of the straight portion.

13. The touch panel as claimed in claim 10, wherein a distance between two adjacent vertical portions is greater than a width of the touch module.

14. The touch panel as claimed in claim 11, wherein a width of the collection area corresponding to the straight portion is equal to a product of a number of the touch signal lines correspondingly connected to the connection module and a sum of a spacing between two adjacent touch signal lines and a width of the touch signal line.

15. The touch panel as claimed in claim 8, wherein the touch signal lines corresponding to a same column are disposed in parallel and at equal intervals.

16. The touch panel as claimed in claim 8, wherein the touch integrated module comprises a first touch integrated module and a second touch integrated module, and the first touch integrated module and the second touch integrated module are symmetrically disposed along a center line of the touch panel.

17. A display device, comprising the touch panel having a display area and a non-display area adjacent to the display area, the touch panel comprising:
touch modules, the touch modules arranged in an array being disposed in the display area of the touch panel; and
touch signal lines, one end of each of the touch signal lines being electrically connected to the touch module correspondingly, another end of the each of the touch signal lines extending into the non-display area;
wherein a display integrated module, at least one touch integrated module, and at least one connection module are disposed in the non-display area, the connection module is electrically connected to the touch integrated module correspondingly, and the another end of the each of the touch signal lines is electrically connected to the connection module correspondingly.

18. The display device as claimed in claim 17, wherein the touch signal lines corresponding to a same column are disposed in parallel and at equal intervals.

19. The display device as claimed in claim 17, wherein the touch integrated module comprises a first touch integrated module and a second touch integrated module, and the first touch integrated module and the second touch integrated module are symmetrically disposed along a center line of the touch panel.

20. The display device as claimed in claim 17, wherein the non-display area comprises a bezel area and a bendable area, the bezel area and the bendable area are disposed adjacent to each other, and the bendable area is close to an edge of the touch panel.
